(19) United States
(12) Patent Application Publication
(10) Pub. No.: US 2019/0380504 A1
(43) Pub. Date: Dec. 19, 2019

(54) INFLATABLE PILLOW SYSTEM

(71) Applicants: David Therkildsen, Fort Wayne, IN (US); Steve Hughes, Fort Wayne, IN (US)

(72) Inventors: David Therkildsen, Fort Wayne, IN (US); Steve Hughes, Fort Wayne, IN (US)

(21) Appl. No.: 16/176,675

(22) Filed: Oct. 31, 2018

Related U.S. Application Data
(63) Continuation-in-part of application No. 14/953,169, filed on Nov. 27, 2015, now abandoned.
(60) Provisional application No. 62/085,407, filed on Nov. 28, 2014.

(51) Int. Cl. A47C 27/08; A47C 4/54; A47C 27/10; G05D 16/20

(52) U.S. Cl. CPC A47C 27/083; A47C 4/54; G05D 16/204; A47C 27/10; A47C 27/082

(57) ABSTRACT

An inflatable pillow system includes a pillow formed of an upper and lower bladder that may be independently inflated and deflated. A controller includes an air mover, a valve assembly, and a control box. The valve assembly includes an air line to the upper bladder, and an air line to the lower bladder. Each of an upper air line valve and a lower air line valve is urged into a closed position by an valve spring, and is movable into an open position by an valve servo. The air line valves may include hollow valve plungers, so that the valve springs extend into the plungers. The control box has an input for inflating and deflating the upper bladder, and an input for inflating and deflating the lower bladder.

### CROSS-REFERENCE TO RELATED APPLICATIONS

The present application is a continuation-in-part of U.S. application Ser. No. 14/953,169, filed Nov. 27, 2015, which claims priority to U.S. Provisional No. 62/085,407, filed Nov. 28, 2014, the entire contents of all of which are herein incorporated by reference.

### BACKGROUND

### Field of Invention

Embodiments described herein generally relate to an inflatable pillow system, and more particularly pertains to raising a leg supporting surface on a recliner chair, bed, couch, and etcetera, and for selectively varying the extent of such raising, the raising and the selective varying being done in a safe, convenient, and economical manner, the raising and the selective varying being done by the unassisted and independent patient, or by an on-site caregiver.

### Related Art

Post-operative patients and others having heart, circulation, or fluid retention problems potentially leading to fluid retention in the legs are often advised to keep their legs elevated during a period of convalescence. Often, these individuals may be physically weak, so that the act of repositioning and/or lifting their legs onto or over ad hoc pillow or solid foam arrangements is difficult or impossible. Furthermore, prior art inflatable body supporting devices, such as inflatable mattresses or furniture, generally exhibit a proportionate relationship between the firmness of the elevating surface and the distance of elevation. That is to say, if a prior art inflatable body supporting device is fully inflated so that the body is fully elevated, the elevating surface may be firmer than desired. If the firmness of the elevating surface of a prior art inflatable body supporting surface is reduced by lowering the air pressure, the desired elevation of the body may not be accomplished.

Accordingly, there is an unmet need for a system and method for elevating patients' legs to a desired elevation simply, conveniently, and unassisted, while separately controlling the firmness of the elevating surface.

### SUMMARY

Embodiments described herein relate to an Inflatable Pillow System for elevating patients' legs. A pillow is adapted to be placed on a leg supporting surface of a recliner chair, bed, or couch, for non-limiting example. The pillow is formed of a lower bladder and an upper bladder, and has a controller by which the patient may independently control the inflation of the lower bladder or upper bladder. The amount of inflation of the upper bladder largely controls the firmness of the leg supporting surface. The amount of inflation of the lower bladder largely controls the amount of elevation of the leg or legs. The upper bladder has a rectangular top panel, a rectangular bottom panel, a rectangular forward panel, a rectangular rearward panel, and trapezoidal side panels. The lower bladder has a rectangular top panel, a rectangular bottom panel, a rectangular forward panel, a rectangular rearward panel, and rectangular side panels. The bottom panel of the upper bladder is coupled to the top panel of the lower bladder. In this manner an enlarged cross sectional configuration is formed. Stiffening plates may be provided in the rectangular bottom panel of the lower bladder for stability. Straps and positioning cords may be provided for attaching the pillow to the leg section of the recliner chair and/or repositioning the pillow as needed.

The controller includes an air mover, a valve assembly, and a wired or wireless control box by which the air mover and valve assembly are controlled using buttons. A quick release valve may be provided for rapidly deflating the Inflatable Pillow System when necessary. By way of the air mover, valve assembly, and/or quick release valve, the upper and lower bladders of the pillow may be independently inflated or deflated, and/or rapidly deflated jointly, according to the various embodiments of the Inflatable Pillow System disclosed herein. If used, the quick release valve may use a primary piston with opposing cone shaped sections that is operable to move in either of two directions and thereby force open conical stoppers in upper and lower release lines, as will be explained in further detail. Alternately, a similar primary piston with cone shaped sections may be used in conjunction with individual reciprocable components to effect the opening of the conical stoppers in the upper and lower release lines, which will again be explained in greater detail.

Alternate embodiments of the Inflatable Pillow System are provided for use with parts of the body other than the legs. Further embodiments of the Inflatable Pillow System provide a valve and blower assembly recess or chamber, in order to provide a location for various embodiments of the blower and valve assembly. The blower and valve assembly may include a blower assembly connected to a valve assembly, or an integrated blower and valve assembly. In either case, the valve assembly is in turn fluidly coupled to the lower bladder and to the upper bladder, thereby enabling the blower and valve assembly to selectively and controllably provide for the inflation and deflation of the lower bladder and of the upper bladder. A muffler/intake diffuser may be connected to the intake of the blower and function to reduce noise and to prevent the blower from becoming occluded by fabric of the pillow or of its outer case.

The valve assembly may include an upper air line valve with an upper air line valve plunger having an upper air line valve spring and an upper air line valve seal. The upper air line valve spring may urge the upper air line valve with its upper air line valve seal into a closed position, thereby closing off airflow between the interior of the blower and valve assembly and the upper bladder. An upper air line valve servo may be used to selectively lift the upper air line valve, compressing the spring and allowing airflow between the interior of the blower and valve assembly and the upper bladder. The upper air line valve spring, upper air line valve plunger, and upper air line valve seal may further function as a pressure relief valve for the upper bladder. Similarly, the valve assembly may include a lower air line valve with a lower air line valve plunger having a lower air line valve spring and a lower air line valve seal. The lower air line valve spring may urge the lower air line valve with its lower air line valve seal into a closed position, thereby closing off airflow between the interior of the blower and valve assembly and the lower bladder. A lower air line valve servo may be used to selectively lift the lower air line valve, compressing the spring and allowing airflow between the interior of the blower and valve assembly and the lower bladder. The lower air line valve spring, lower air line valve plunger, and lower air line valve seal may further function as a pressure relief valve for the lower bladder.

The upper air line valve when open controls air flow into the upper bladder when the blower motor is running and air flow out of the upper bladder when the blower motor is not running. When closed, the upper air line valve prevents air from escaping from the upper bladder. Similarly, the lower air line valve when open controls air flow into the lower bladder when the blower motor is running and air flow out of the lower bladder when the blower motor is not running. When closed, the lower air line valve prevents air from escaping from the lower bladder. In order to provide a greater spring length while allowing for a compact valve assembly or integrated blower and valve assembly, the upper and lower air line valve plungers may be hollow. In this way, part of the overall length of each spring is contained within each air line valve plunger, thereby lowering the necessary spring rate and minimizing the force required by the air line valve servos in order to lift the air line valve plungers. Each of the upper air line valve servo and upper air line valve, and lower air line valve servo and lower air line valve may be configured to be capable of an intermediate position, which may be used for minor adjustments or to bleed air in a controlled fashion from the upper bladder or lower bladder, respectively.

According to one embodiment of the Inflatable Pillow System, the inflatable pillow system includes a pillow formed of a lower bladder and an upper bladder. The upper bladder is coupled to the lower bladder to form an enlarged cross sectional configuration. A controller is provided for independently inflating and deflating the upper bladder and the lower bladder. The controller includes an air mover, a valve assembly in fluid communication with the air mover, and a control box operatively coupled to the air mover and to the valve assembly. The valve assembly includes an upper air line coupled to the upper bladder, and a lower air line coupled to the lower bladder. An upper air line valve is in fluid communication with the upper air line. The upper air line valve is urged into a closed position by an upper air line valve spring, and is movable into an open position by an upper air line valve servo. A lower air line valve is in fluid communication with the lower air line. The lower air line valve is urged into a closed position by a lower air line valve spring, and is movable into an open position by a lower air line valve servo. The control box has an input for inflating and raising the upper bladder, an input for deflating and lowering the upper bladder, an input for inflating and raising the lower bladder, and an input for deflating and lowering the lower bladder.

According to another embodiment of the Inflatable Pillow System having a pillow formed of a lower bladder and an upper bladder, the upper bladder being coupled to the lower bladder to form an enlarged cross sectional configuration, a controller of the Inflatable Pillow System includes an air mover, a valve assembly in fluid communication with the air mover, and a control box operatively coupled to the air mover and to the valve assembly. The valve assembly has an upper air line coupled to the upper bladder, and a lower air line coupled to the lower bladder. An upper air line valve is in fluid communication with the upper air line. The upper air line valve is urged into a closed position by an upper air line valve spring, and is movable into an open position by an upper air line valve servo. A lower air line valve is in fluid communication with the lower air line. The lower air line valve is urged into a closed position by a lower air line valve spring, and movable into an open position by a lower air line valve servo. The control box is configured for independently inflating and deflating the upper bladder and the lower bladder. The control box has an input for inflating and raising the upper bladder, an input for deflating and lowering the upper bladder, an input for inflating and raising the lower bladder, and an input for deflating and lowering the lower bladder.

According to another embodiment of the Inflatable Pillow System, a method for elevating at least one extremity of a patient includes several steps. The first step is forming a pillow out of a lower bladder and an upper bladder. The second step is coupling the upper bladder to the lower bladder to form an enlarged cross sectional configuration. The third step is providing a controller for independently inflating and deflating the upper bladder and the lower bladder. The controller includes an air mover, a valve assembly in fluid communication with the air mover, and a control box operatively coupled to the air mover and to the valve assembly. The valve assembly has an upper air line coupled to the upper bladder, and a lower air line coupled to the lower bladder. An upper air line valve is in fluid communication with the upper air line. The upper air line valve is urged into a closed position by an upper air line valve spring, and is movable into an open position by an upper air line valve servo. A lower air line valve is in fluid communication with the lower air line. The lower air line valve is urged into a closed position by a lower air line valve spring, and is movable into an open position by a lower air line valve servo. The control box has an input for inflating and raising the upper bladder, an input for deflating and lowering the upper bladder, an input for inflating and raising the lower bladder, and an input for deflating and lowering the lower bladder.

There has thus been outlined, rather broadly, some features of the Inflatable Pillow System in order that the detailed description thereof that follows may be better understood and in order that the present contribution to the art may be better appreciated. There are, of course, additional features of the Inflatable Pillow System that will be described hereinafter and which may form part of the subject matter of the claims attached. In this respect, before explaining at least one embodiment of the Inflatable Pillow System in detail, it is to be understood that the Inflatable Pillow System is not limited in its application to the details of construction and to the arrangements of the components set forth in the following description or illustrated in the drawings. The Inflatable Pillow System is capable of other embodiments and of being practiced and carried out in various ways. Also, it is to be understood that the phraseology and terminology employed herein are for the purpose of descriptions and should not be regarded as limiting. As such, those skilled in the art will appreciate that the conception, upon which this disclosure is based, may readily be utilized as a basis for the designing of other structures, methods and systems for carrying out the several purposes of the Inflatable Pillow System. It is important, therefore, that the claims be regarded as including such equivalent constructions insofar as they do not depart from the spirit and scope of the Inflatable Pillow System.

Embodiments of the Inflatable Pillow System provide a new and improved inflatable pillow system which may be easily and efficiently manufactured and marketed. Embodiments of the Inflatable Pillow System are durable and reliable, and are susceptible of a low cost of manufacture with regard to both materials and labor, and accordingly are susceptible of low prices of sale to the consuming public, thereby making such Inflatable Pillow System economically available to the buying public. The Inflatable Pillow System may be used for raising a leg supporting surface on a recliner chair and for selectively varying the extent of such raising, the raising and the selective varying being done in a safe, convenient, economical, and independent manner. These together with other objects of the Inflatable Pillow System, along with the various features of novelty which characterize the Inflatable Pillow System, are pointed out with particularity in the claims annexed to and forming a part of this disclosure.

### DESCRIPTION OF THE DRAWINGS

The above-mentioned and other features of embodiments of the Inflatable Pillow System, and the manner of their working, will become more apparent and will be better understood by reference to the following description of embodiments of the Inflatable Pillow System taken in conjunction with the accompanying drawings, wherein:

FIG. 1 is a side elevational view of an embodiment of the Inflatable Pillow System, as described herein;

FIG. 2 is a side elevational view of the embodiment of the Inflatable Pillow System shown in FIG. 1, as described herein;

FIG. 3 is a front elevational view of the embodiment of the Inflatable Pillow System shown in the prior Figures, as described herein;

FIG. 4 is a bottom view of the embodiment of the Inflatable Pillow System of FIGS. 1 through 3 taken along line 4-4 in FIG. 3, as described herein;

FIG. 5 is a cross sectional view of the embodiment of the Inflatable Pillow System of FIGS. 1 through 3 taken along line 5-5 in FIG. 3, as described herein;

FIG. 6 is an enlarged plan view of the control box shown in FIG. 1, as described herein;

FIG. 7 is a side elevational view of another embodiment of the Inflatable Pillow System, as described herein;

FIG. 8 is a front elevational view of the embodiment of the Inflatable Pillow System shown in FIG. 7, as described herein;

FIG. 9 is a plan view of the embodiment of the Inflatable Pillow System of FIGS. 7 and 8 taken along line 9-9 in FIG. 8, as described herein;

FIG. 10 is a cross sectional view of the embodiment of the Inflatable Pillow System of FIGS. 7 and 8 taken along line 10-10 in FIG. 8, as described herein;

FIG. 11 is a cross sectional view of the embodiment of the Inflatable Pillow System of FIGS. 7 and 8 taken along line 11-11 of FIG. 10, as described herein;

FIG. 12 is a side elevational view of the dual chambers of the embodiment of the Inflatable Pillow System shown in FIGS. 1 through 3, as described herein;

FIG. 13 is a cross sectional view of the valve of the embodiment of the Inflatable Pillow System illustrated in FIGS. 7, 8, and 9, as described herein;

FIG. 14 is a cross sectional view of the valve shown in FIG. 13 with the piston moved from the contain orientation to the release orientation, as described herein;

FIG. 14A is a cross sectional view of an alternate embodiment of the valve shown in FIGS. 13 and 14, as described herein;

FIG. 14B is a cross sectional view of the embodiment of the valve shown in FIG. 14A with the piston moved from the contain orientation to the release orientation, as described herein;

FIG. 15 is a side elevational view of a dual chamber formed in accordance with an alternate embodiment of the Inflatable Pillow System, as described herein;

FIG. 15A is a side elevational view of a dual chamber formed in accordance with another alternate embodiment of the Inflatable Pillow System, as described herein;

FIG. 16 is a side elevational view of a dual chamber formed in accordance with another alternate embodiment of the Inflatable Pillow System, as described herein;

FIG. 17 is a rear right isometric view of another embodiment of the Inflatable Pillow System, as described herein, as described herein;

FIG. 18 is an isometric view of an embodiment of the blower and valve assembly of the Inflatable Pillow System, as described herein;

FIG. 19 is an exploded isometric view of the embodiment of the blower and valve assembly of the Inflatable Pillow System shown in FIG. 18, as described herein;

FIG. 20 is an exploded isometric view of another embodiment of the blower and valve assembly of the Inflatable Pillow System, as described herein;

FIG. 21 is a partial isometric view of the embodiment of the blower and valve assembly of the Inflatable Pillow System shown in FIG. 20, as described herein;

FIGS. 22A, 22B, and 22C are front views of an embodiment of an air line valve servo used in the blower and valve assembly of the Inflatable Pillow System shown in FIGS. 20 and 21, arranged in the valve full open position, in the valve bleed position, and in the valve closed position, respectively, as described herein;

FIG. 23 is a bottom isometric view of an upper housing of the embodiment of the blower and valve assembly shown in FIGS. 20 and 21, as described herein;

FIG. 24 is a top isometric view of a lower housing of the embodiment of the blower and valve assembly shown in FIG. 20, as described herein;

FIG. 25 is a bottom isometric view of a valve plunger used in the blower and valve assembly of the Inflatable Pillow System shown in FIGS. 20 and 21;

FIG. 26 is a view showing an embodiment of the Inflatable Pillow System inflated with the recliner in the reclined position;

FIG. 26A is a view showing seat straps of an embodiment of the Inflatable Pillow System with tuck pads;

FIG. 27 is a view showing seat straps connected to an outer case of the pillow of an embodiment of the Inflatable Pillow System; and

FIG. 27A is a view showing seat straps with adjustable snap connectors or side release buckles of an embodiment of the Inflatable Pillow System.

Corresponding reference numbers indicate corresponding parts throughout the several views. The exemplifications set out herein illustrate embodiments of the Inflatable Pillow System, and such exemplifications are not to be construed as limiting the scope of the claims in any manner.

### DETAILED DESCRIPTION

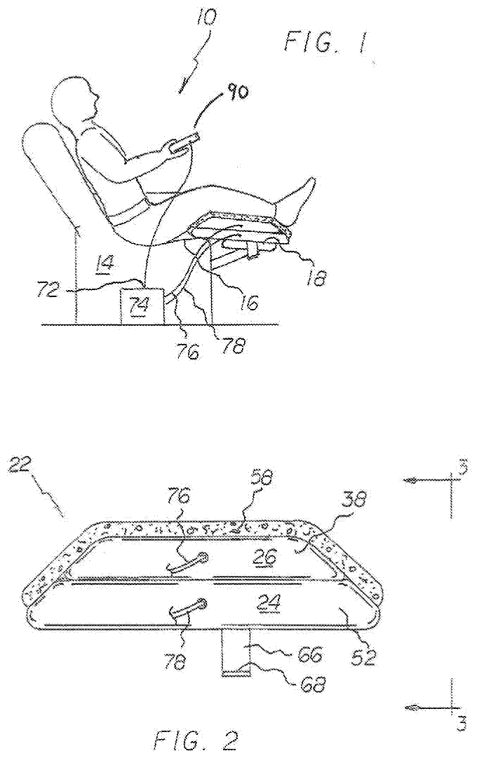

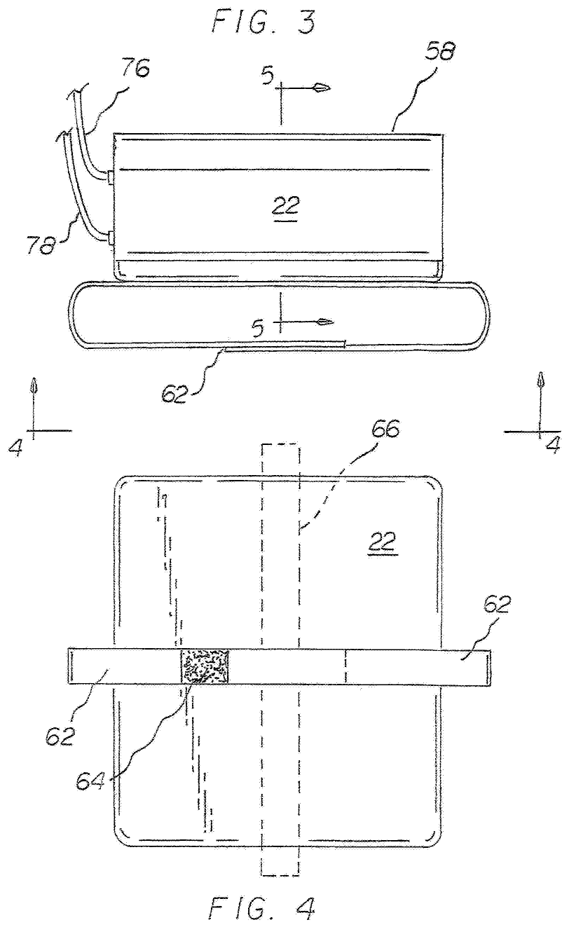

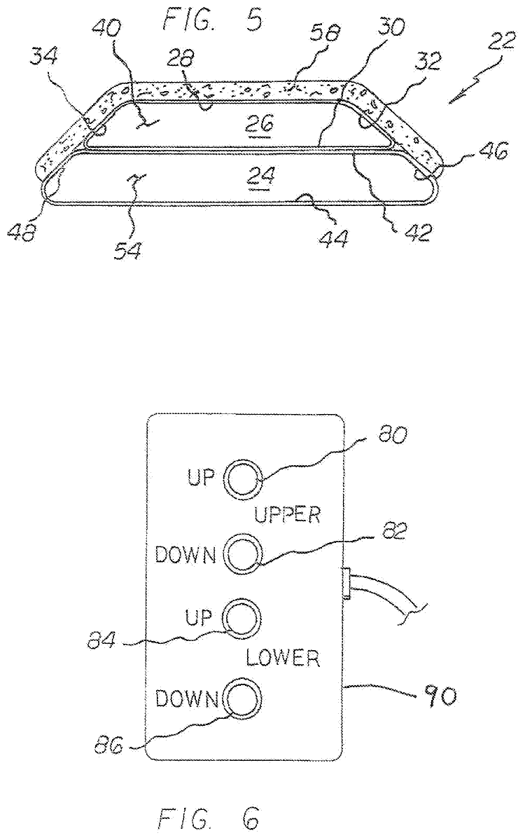

Referring now to FIGS. 1-6, a side view of an embodiment of an Inflatable Pillow System 10 in use is shown. As illustrated, the inflatable pillow system 10 may be used as a leg supporting surface on a recliner chair 14 and is capable of selectively varying the extent of such raising. The recliner chair 14 may have a seating section 16 and a leg section 18, which may be movable between a generally vertical lowered orientation and a generally horizontal raised orientation. The inflatable pillow system 10 may be arranged upon the leg section 18 of the recliner chair 14, and includes a pillow 22 formed of an upper bladder 26 and a lower bladder 24. The inflatable pillow system 10 further includes a control assembly 72.

The upper bladder 26 is made up of a rectangular top panel 28, a rectangular bottom panel 30, a rectangular forward panel 32, a rectangular rearward panel 34, and trapezoidal side panels 38, which together form an upper chamber 40. Similarly, the lower bladder 24 is made up of a rectangular top panel 42, a rectangular bottom panel 44, a rectangular forward panel 46, a rectangular rearward panel 48, and trapezoidal side panels 52, which together form a lower chamber 54. The upper bladder 26 is coupled to the lower bladder 24. An outer case 58 is provided. In this manner an enlarged trapezoidal cross sectional configuration is formed. The rectangular bottom panel 44 of the lower bladder 24 may have a length greater than the length of the leg section 18 of the recliner chair 14. In this manner the pillow 22 may rest on both the seating section 16 and the leg section 18 of the recliner chair 14 when the leg section 18 is in the raised generally horizontal orientation. A set of first straps 62 may be sewn to the forward and rearward panels of the outer case 58, and may be provided with releasable fasteners 64. The first straps 62 may be used to couple the pillow 22 to the leg section 18 of the recliner chair 14. A set of second straps 66 may also be sewn to the side panels of the outer case 58, and may also be provided with releasable fasteners 68. The second straps 66 may also be used to couple the pillow 22 to the leg section 18 of the recliner chair 14.

The inflatable pillow system further includes a control assembly 72 having an air mover 74 and a control box 90. The air mover 74 has an upper air line 76 coupled to the upper chamber 40, and a lower air line 78 coupled to the lower chamber 54. The control box 90 is operatively coupled to the air mover 74, and has a first up button 80 for inflating and raising the upper bladder 26 and a first down button 82 for deflating and lowering the upper bladder 26. The control box 90 also has a second up button 84 for inflating and raising the lower bladder 24 and a second down button 86 for deflating and lowering the lower bladder 24.

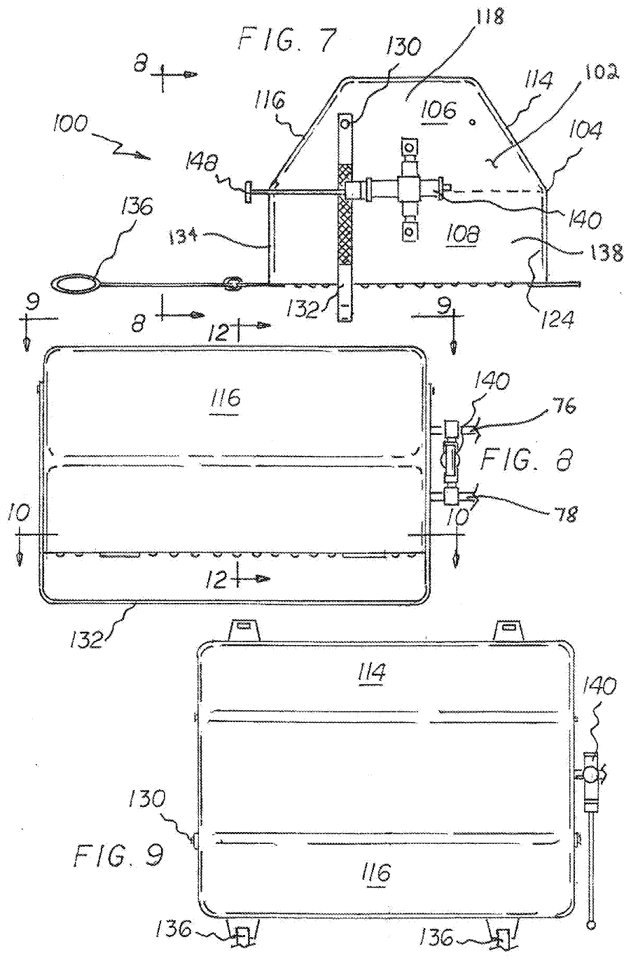

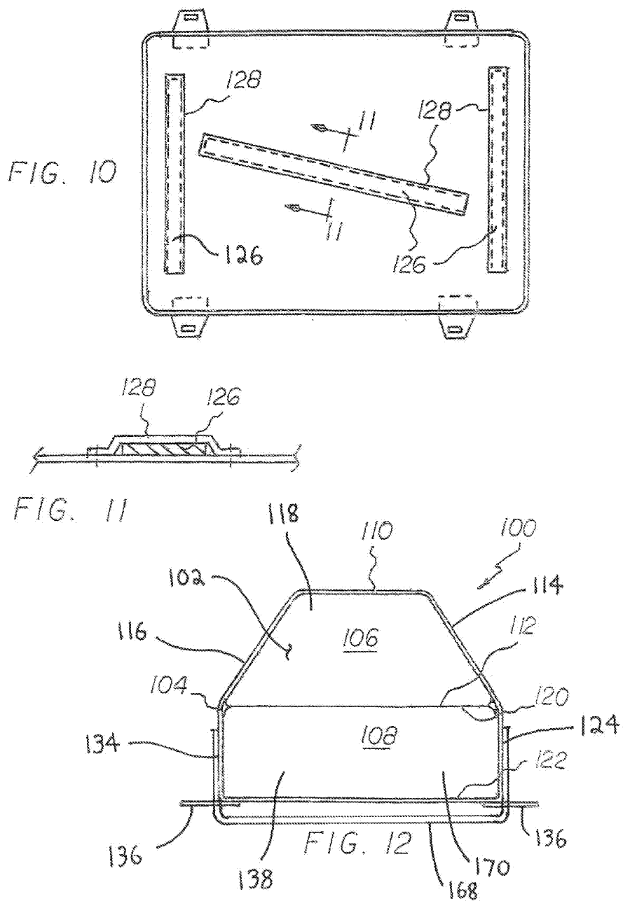

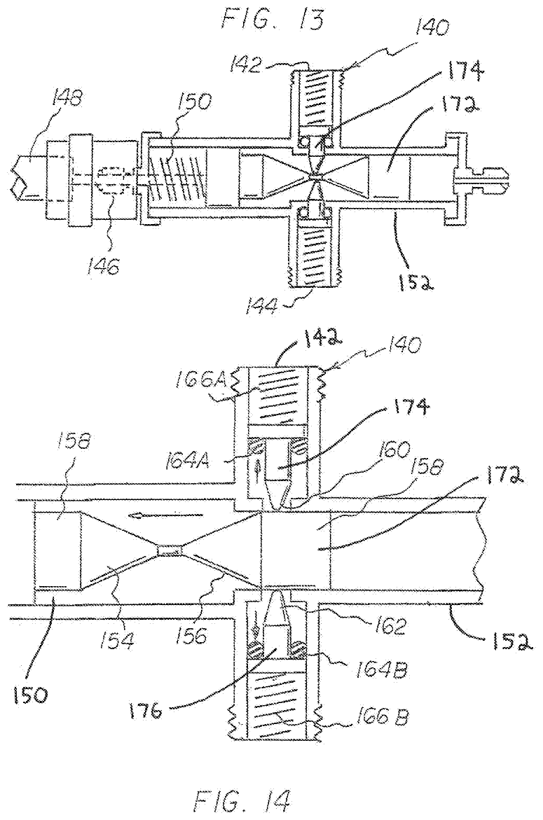

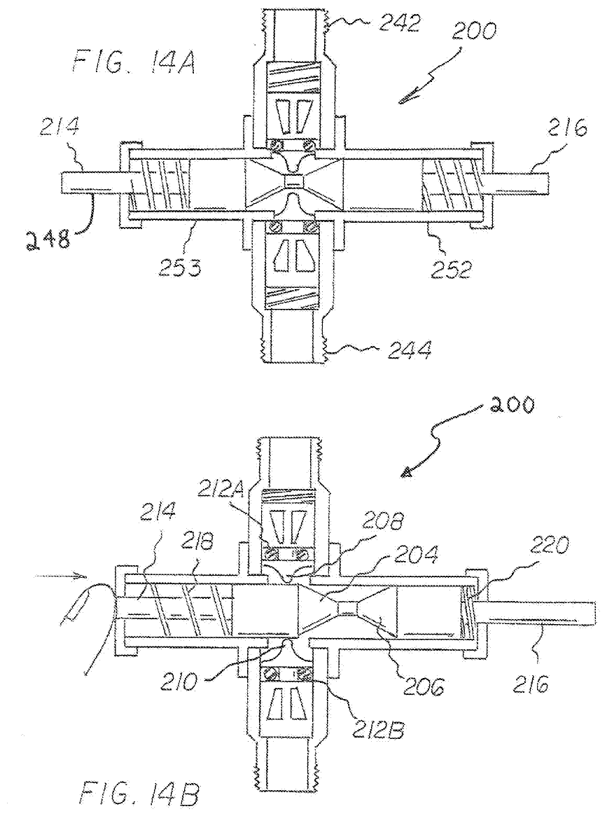

Turning now to FIGS. 7-12, another embodiment of an inflatable pillow system 100 for supporting a patient and for selectively varying the extent of such supporting is shown. The inflatable pillow system 100 again has a lower bladder 108 and an upper bladder 106. The upper bladder 106 is again made up of a rectangular top panel 110, a rectangular bottom panel 112, a rectangular forward panel 114, a rectangular rearward panel 116, and trapezoidal side panels 118, which together form an upper chamber 102. The lower bladder 108 again has a rectangular top panel 120, a rectangular bottom panel 122, a rectangular forward panel 124, a rectangular rearward panel 134, and trapezoidal side panels 138, which together form a lower chamber 170. The upper bladder 106 is coupled to the lower bladder 108 using an outer case 104 to form an enlarged cross sectional configuration.

A first strap 132 may be attached to the outer case 104 using releasable fasteners 130. A second strap 168 may be attached to the lower bladder 108 for coupling the inflatable pillow system 100 to the leg section 18 of the recliner chair 14. A set of positioning cords 136 may be attached to the outer case 104 and may be arranged to extend rearward for being held and manipulated by a user for concurrently repositioning the upper bladder 106 and lower bladder 108. A plurality of stiffening plates 126 may be provided. Each stiffening plate 126 may be positioned within a rectangular pocket 128 formed in the rectangular bottom panel 122 of the lower bladder 108. In this manner stability is added to the rectangular bottom panel 122 of the lower bladder 108 and to the inflatable pillow system 10 during use.

As before, a control assembly 72 is provided (not shown in FIGS. 7-12). The control assembly 72 again includes an air mover 74 including a pneumatic pump or blower or the like (also not shown in FIGS. 7-12). The air mover 74 has an upper air line 76 and a lower air line 78. The upper air line 76 is coupled to the upper chamber 102, and the lower air line 78 is coupled to the lower chamber 170. The control assembly 72 again includes a control box 90 (not shown in FIGS. 7-12), which is operatively coupled to the air mover 74. The control box 90 again has a first up button 80 for inflating and raising the upper bladder 106, and a first down button 82 for deflating and lowering the upper bladder 106. The control box 90 again has a second up button 84 for inflating and raising the lower bladder 108, and a second down button 86 for deflating and lowering the lower bladder 108. The embodiment of the inflatable pillow system 100 shown in FIGS. 7-12 is further provided with a quick release valve 140 for the quick release and deflating of the inflatable pillow system 100.

FIGS. 13 and 14 are cross sectional views of an embodiment of the quick release valve 140 of the embodiment of the Inflatable Pillow System 100 illustrated in FIGS. 7, 8, and 9. The quick release valve 140 is provided for rapidly deflating the upper bladder 106 and the lower bladder 108. FIG. 13 shows the quick release valve 140 having its primary piston 172 in the valve closed orientation, and FIG. 14 shows the quick release valve 140 having its primary piston 172 in the valve released orientation. The quick release valve 140 includes a vertically disposed upper release line 142, which may be coupled to the upper bladder 106 (not shown in FIGS. 13 and 14). An axially aligned lower release line 144 may be coupled to the lower bladder 108 (not shown in FIGS. 13 and 14). The quick release valve 140 includes a horizontally disposed interior actuator line 150. An axially aligned exhaust line 152 is also provided. The horizontally disposed interior actuator line 150 and the axially aligned exhaust line 152 contain the primary piston 172. The primary piston 172 is reciprocable in the horizontally disposed interior actuator line 150 and in the axially aligned exhaust line 152. The primary piston 172 may be formed as one through piece, or as a construction of subparts. The primary piston 172 has two cone shaped sections 154 and 156 having apexes coupled together axially inwardly and cylindrical extensions 158 extending axially outwardly.

A conical upper piston 174 is reciprocable in the vertically disposed upper release line 142, and is provided with a conical upper stopper 160 and an upper O-ring 164A. An upper coil spring 166A urges the conical upper piston 174 with its conical upper stopper 160 and upper O-ring 164A into sealing contact with the axially aligned exhaust line 152. A conical lower piston 176 is reciprocable in the axially aligned lower release line 144, and is provided with a conical lower stopper 162 and a lower O-ring 164B. A lower coil spring 166B urges the conical lower piston 176 with its conical lower stopper 162 and lower O-ring 164B into sealing contact with the axially aligned exhaust line 152. A handler 148 has an interior end 146 that is coupled to the primary piston 172, and an exterior end (not shown) that is under control of the user. In this manner axial movement of the handler 148 initiates activation of the quick release valve 140.

As explained above, FIGS. 13 and 14 illustrate one embodiment of the quick release valve 140. In this embodiment, the handler 148 and the primary piston 172 act as a single reciprocable component. That is to say that the handler 148 and the primary piston 172 are adapted to be pulled and/or pushed to initiate activation of the quick release valve 140. FIGS. 14A and 14B illustrate another embodiment of the quick release valve 200 wherein the handler 248 of a quick release valve 200 is formed of one piece with two reciprocable components 214 and 216. The two reciprocable components 214 and 216 are located in similarly configured, axially aligned lines 253 and 252, respectively. Shaped components 204 and 206 are urged centrally by coil springs 218 and 220, respectively. In this manner movement of stoppers 208 and 210, and O-rings 212A and 2128, into and out of contact with vertically disposed upper release line 242 and axially aligned lower release line 244 is controlled by the two reciprocable components 214 and 216. That is to say, each of the two reciprocable components 214 and 216 are adapted to be pushed to initiate activation of a quick release valve 200.

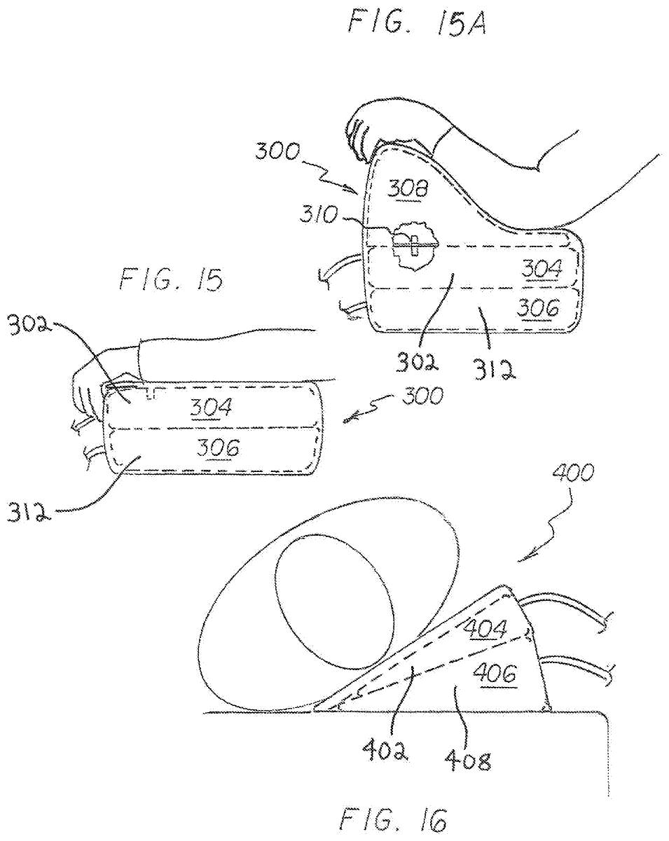

FIG. 15 illustrates an additional alternate embodiment of the inflatable pillow system 300. In this embodiment, the upper bladder 304 has side panels 302 in a rectangular configuration and the lower bladder 306 has side panels 312 in a rectangular configuration. FIG. 15A illustrates a variation of the inflatable pillow system 300 wherein the side panels 302 of the upper bladder 304 are again in a rectangular configuration, and the side panels 312 of the lower bladder 306 are again in a rectangular configuration. Additionally, the upper bladder 304 further includes a topmost bladder 308 having a cross sectional configuration in a serpentine shape. In this manner an arm of a user is held in an angular orientation. The inflatable pillow system 300 of FIG. 15A further includes a pressure activated valve 310 intermediate the upper bladder 304 and the topmost bladder 308. In this manner the topmost bladder 308 is inflated after filling the upper bladder 304.

In a further embodiment, shown in FIG. 16, the top bladder 404 of the inflatable pillow system 400 has side panels 402 in a triangular configuration and the bottom bladder 406 has side panels 408 in a triangular configuration. In this manner, the back of a user is supported in an angular orientation and rolling over a supine patient is facilitated.

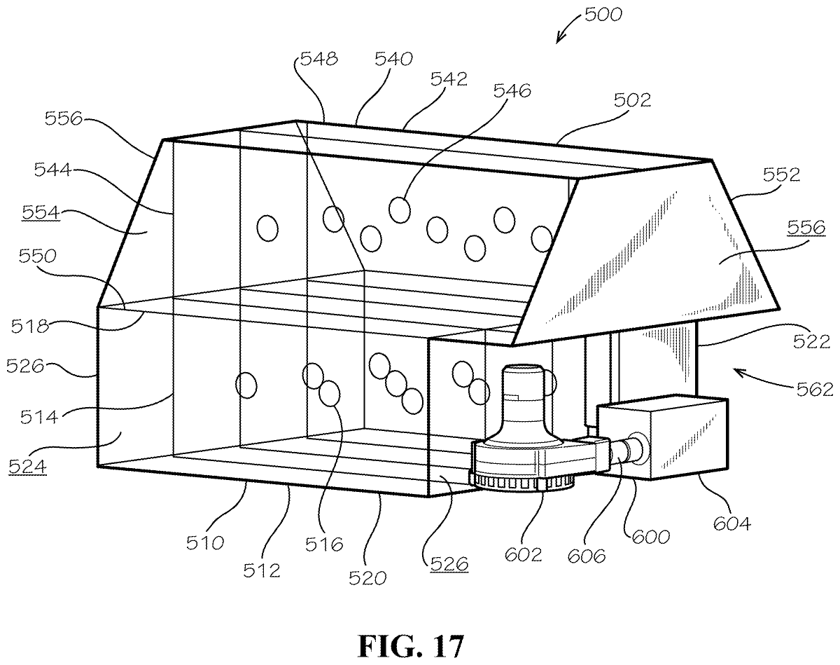

Turning now to FIG. 17, an isometric view of another embodiment of an Inflatable Pillow System 500 is shown. As before, the inflatable pillow system 500 may be arranged upon the leg section 18 of a recliner chair 14 (not shown), and includes a pillow 502 formed of an upper bladder 540 and a lower bladder 510. Again, the upper bladder 540 is made up of a rectangular top panel 548, a rectangular bottom panel 550, a rectangular forward panel 552, a rectangular rearward panel 554, and trapezoidal side panels 556, which together form an upper chamber 542. The upper chamber 542 may be provided with upper chamber baffles 544 having upper chamber baffle holes 546. Similarly, the lower bladder 510 is made up of a rectangular top panel 518, a rectangular bottom panel 520, a rectangular forward panel 522, a rectangular rearward panel 524, and rectangular side panels 526, which together form a lower chamber 512. The lower chamber 512 may be provided with lower chamber baffles 514 having lower chamber baffle holes 516. The upper bladder 540 is coupled to the lower bladder 510. An outer case 560 (not shown) may be provided.

The length of the lower bladder 510 may be shorter than the length of the upper bladder 540, thereby providing a valve and blower assembly recess or chamber 562, wherein is arranged a blower and valve assembly 600. The blower and valve assembly 600 includes a blower assembly 602 connected to a valve assembly 604 by way of a blower assembly to valve assembly connector 606. The valve assembly 604 is fluidly coupled to the lower chamber 512 of the lower bladder 510 and to the upper chamber 542 of the upper bladder 540, thereby enabling the blower and valve assembly 600 to selectively and controllably provide for the inflation and deflation of the lower bladder 510 and of the upper bladder 540, according to its construction and operation, which will be discussed in greater detail.

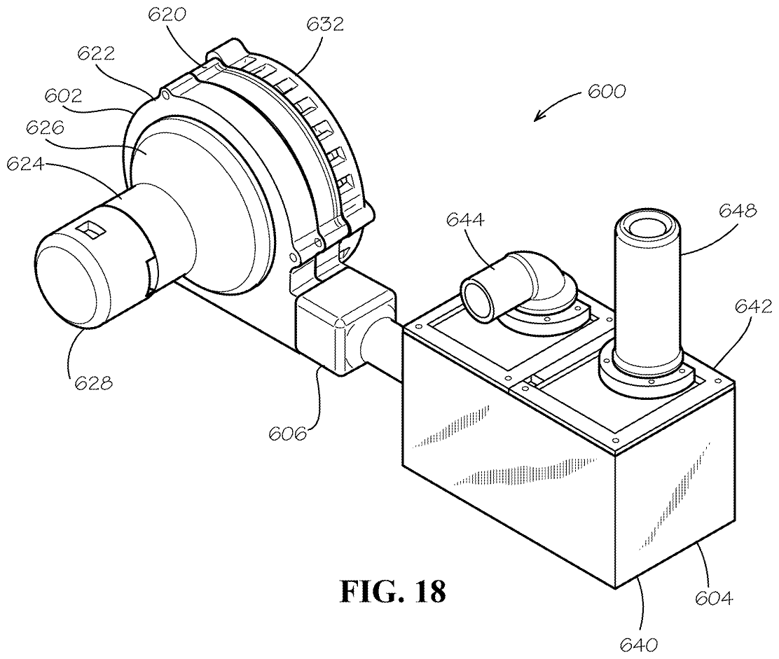

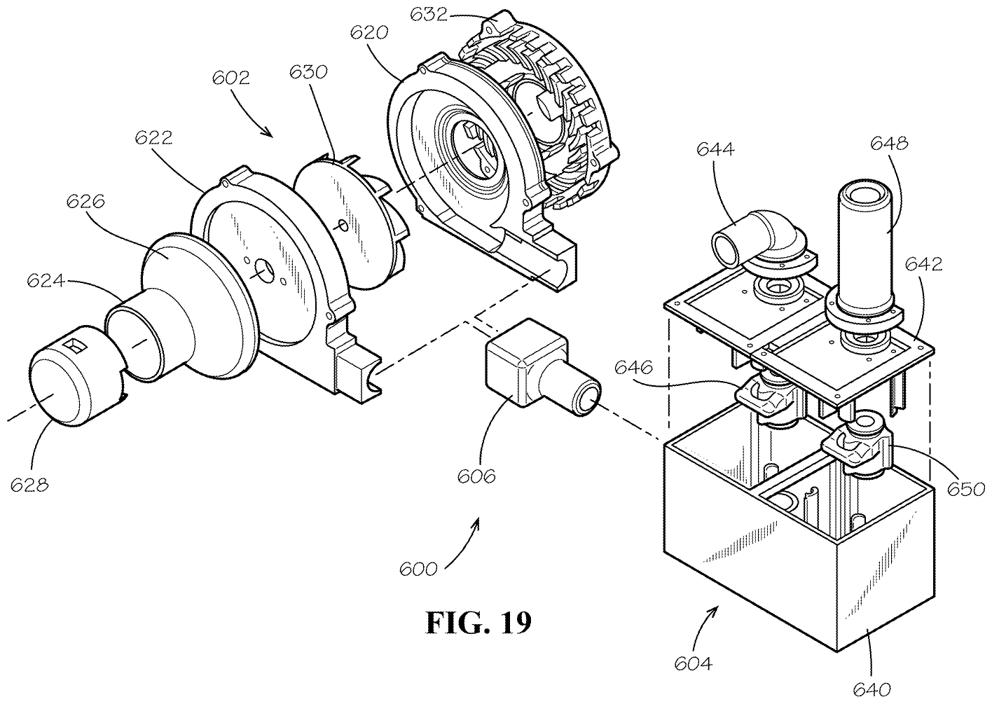

Turning therefore to FIGS. 18 and 19, an embodiment of the blower and valve assembly 600 of the inflatable pillow system 500 is shown in top forward front isometric views in a state of assembly and in an exploded view, respectively. The blower and valve assembly 600 again includes a blower assembly 602 connected to a valve assembly 604 by way of a blower assembly to valve assembly connector 606. The blower assembly 602 includes a blower lower housing 620 and a blower upper housing 622 containing an impeller 630 driven by a blower motor 624. The blower motor 624 is connected to the blower upper housing 622 by way of a blower motor adapter 626, and is protected by a blower motor housing 628. A muffler/intake diffuser 632 is connected to the blower lower housing 620 and functions to reduce noise and to prevent the blower assembly 602 from becoming occluded by fabric of the pillow 502 (not shown) or of its outer case 560.

The valve assembly 604 includes a valve assembly housing 640 and a valve assembly lid 642, and contains an upper air line valve 646 operably connected to an upper air line 644, and a lower air line valve 650 operably connected to a lower air line 648. The upper air line valve 646 when open controls air flow into the upper bladder 540 (not shown) when the blower motor 624 is running and air flow out of the upper bladder 540 when the blower motor 624 is not running. When closed, the upper air line valve 646 prevents air from escaping from the upper bladder 540. Similarly, the lower air line valve 648 when open controls air flow into the lower bladder 510 (not shown) when the blower motor 624 is running and air flow out of the lower bladder 510 when the blower motor 624 is not running. When closed, the lower air line valve 648 prevents air from escaping from the lower bladder 510.

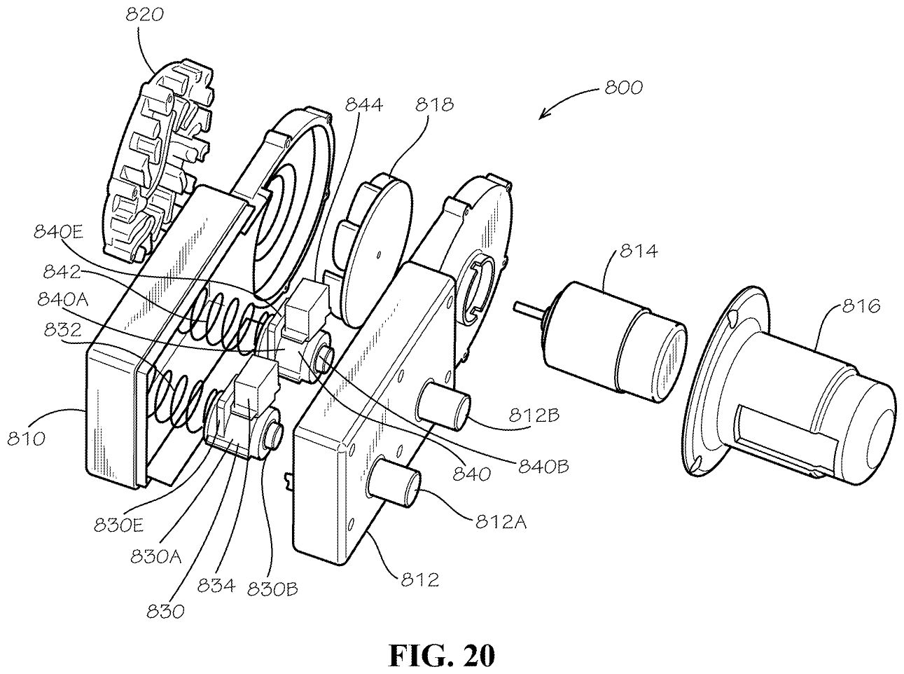

FIG. 20 shows an exploded view of another embodiment of a blower and valve assembly, which is an integrated blower and valve assembly 800. The integrated blower and valve assembly 800 includes an upper housing 812 and a lower housing 810 which contains both the impeller 818 driven by the blower motor 814, and the upper air line valve 830 and the lower air line valve 840. As with the blower motor 624 of the embodiment of the blower assembly 602 of the blower and valve assembly 600 shown in FIGS. 18 and 19, the blower motor 814 of the integrated blower and valve assembly 800 may be protected by a blower motor housing 816 which is adapted to connect to the upper housing 812 and enclose the blower motor 814. A muffler/intake diffuser 820 may again be connected to the lower housing 810, thereby reducing noise and preventing the integrated blower and valve assembly 800 from becoming occluded by fabric of the pillow 502 (not shown) or of its outer case 560 (not shown).

The upper air line valve 830 includes an upper air line valve plunger 830A having an upper air line valve seal 830B. An upper air line valve spring 832 urges the upper air line valve plunger 830A and its upper air line valve seal 830B into a closed position, wherein airflow between the interior of the integrated blower and valve assembly 800 and an upper housing upper air line nipple 812A is closed off. When fluid communication is desired between the interior of the integrated blower and valve assembly 800 and the upper housing upper air line nipple 812A, for example when filling or exhausting the upper bladder 540 (not shown), an upper air line valve servo 834, which may be a type-40 servo, lifts the upper air line valve plunger 830A and its upper air line valve seal 830B, compressing the upper air line valve spring 832 and placing the upper air line valve plunger 830A and its upper air line valve seal 830B into an open position. The upper air line valve spring 832, the upper air line valve plunger 830A, and the upper air line valve seal 830B may further function as a passive pressure relief valve for the upper bladder 540.

Similarly, the lower air line valve 840 includes a lower air line valve plunger 840A having a lower air line valve seal 840B. A lower air line valve spring 842 urges the lower air line valve plunger 840A and its lower air line valve seal 840B into a closed position, wherein airflow between the interior of the integrated blower and valve assembly 800 and a lower housing upper air line nipple 812B is closed off. When fluid communication is desired between the interior of the integrated blower and valve assembly 800 and the lower housing upper air line nipple 812B, for example when filling or exhausting the lower bladder 510 (not shown), a lower air line valve servo 844, which may also be a type-40 servo, lifts the lower air line valve plunger 840A and its lower air line valve seal 840B, compressing the lower air line valve spring 842 and placing the lower air line valve plunger 840A and its lower air line valve seal 840B into an open position. The lower air line valve spring 842, the lower air line valve plunger 840A, and the lower air line valve seal 840B may further function as a passive pressure relief valve for the lower bladder 510. A printed circuit board 900 may control the operation of the upper air line valve servo 834 of the upper air line valve 830, the lower air line valve servo 844 of the lower air line valve 840, and/or the blower motor 814, in response to inputs by the user of the inflatable pillow system 500 by way of the first up button 80, the first down button 82, the second up button 84, and the second down button 86 of the control box 90 (not shown).

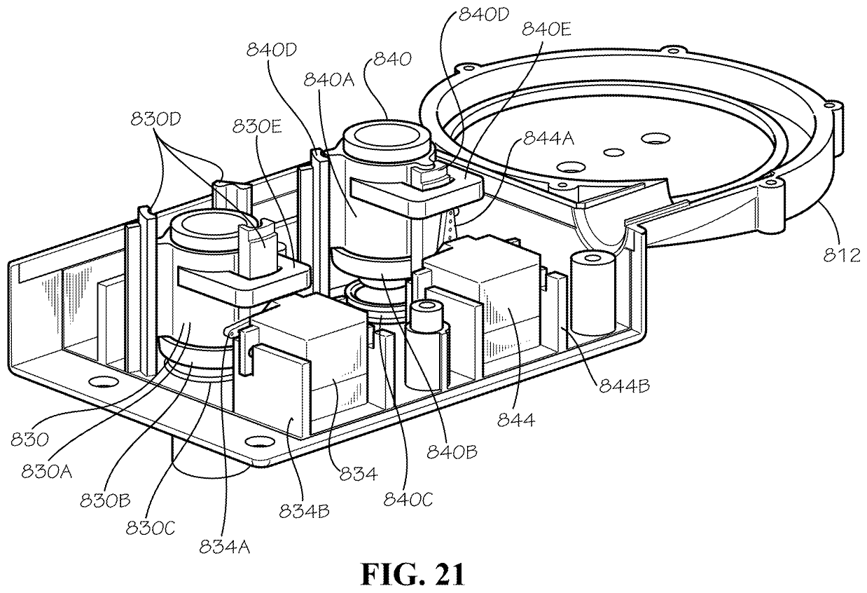

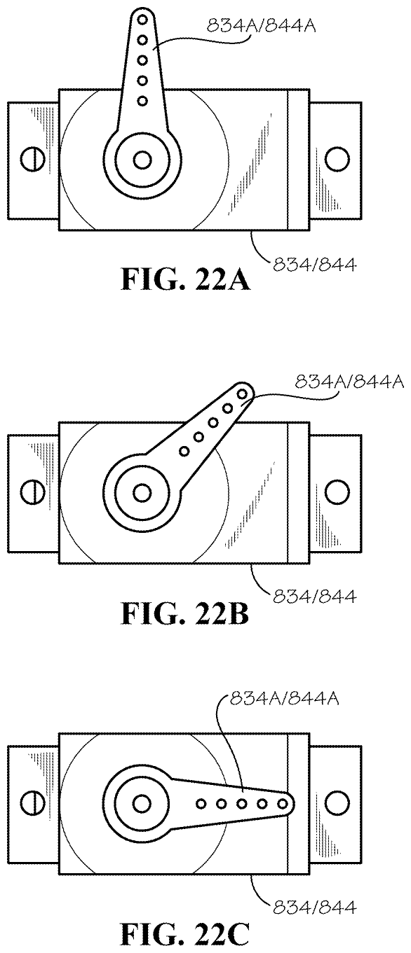

Turning now to remaining FIGS. 21, 22A, 22B, 22C, 23, 24, and 25, further details of the configuration and operation of the upper air line valve 830 and of the lower air line valve 840 are shown. FIG. 21 shows a partial view of the upper housing 812 of the integrated blower and valve assembly 800 with the upper air line valve 830 in a closed position and the lower air line valve 840 in an open position. In the case of the upper air line valve 830, the upper air line valve servo 834, which sits in an upper air line valve servo seat 834B, is inactive, so that its upper air line valve servo arm 834A is horizontal with respect to the upper housing 812, similar to the position of the upper air line valve servo arm 834A of the upper air line servo 834 shown in FIG. 22C. The upper air line valve spring 832 (not shown), therefore, urges the upper air line valve plunger 830A and its upper air line valve seal 830B into engagement with an upper air line valve seal engaging lip 830C, thereby preventing airflow between the interior of the integrated blower and valve assembly 800 and the upper housing upper air line nipple 812A.

The upper air line valve plunger 830A is kept in alignment with the upper air line valve seal engaging lip 830C at all times by way of upper air line valve guides 830D and an upper air line valve loop 830E. The upper air line valve loop 830E further functions as a lifting surface for the upper air line valve servo arm 834A of the upper air line valve servo 834. The upper air line valve plunger 830A is generally hollow in the direction of the upper air line valve spring 832, which upper air line valve spring 832 extends into the hollow upper air line valve plunger 830A and further engages an upper air line valve spring seat 832A in the lower housing 810, thereby allowing for a longer spring in a compact overall integrated blower and valve assembly. Use of a longer upper air line valve spring 832 allows for reduced lifting force by the upper air line valve servo 834, while still preserving a good air seal when the upper air line valve 830 is in the closed position.

In the case of the lower air line valve 840, the lower air line valve servo 844, which sits in a lower air line valve servo seat 844B, is active, so that its lower air line valve servo arm 834A is vertical with respect to the upper housing 812, similar to the position of the lower air line valve servo arm 844A of the lower air line servo 844 shown in FIG. 22A. The lower air line valve spring 842 (not shown), therefore, is compressed so that the lower air line valve plunger 840A and its lower air line valve seal 840B disengages from the lower air line valve seal engaging lip 840C, thereby allowing airflow between the interior of the integrated blower and valve assembly 800 and the upper housing lower air line nipple 812B.

The lower air line valve plunger 840A is again kept in alignment with the lower air line valve seal engaging lip 840C at all times by way of lower air line valve guides 840D and a lower air line valve loop 840E. The lower air line valve loop 840E again further functions as a lifting surface for the lower air line valve servo arm 8444A of the lower air line valve servo 844. The lower air line valve plunger 840A is again generally hollow in the direction of the lower air line valve spring 842, which lower air line valve spring 842 extends into the hollow lower air line valve plunger 840A and further engages a lower air line valve spring seat 842A in the lower housing 810, again allowing for a longer spring in a compact overall integrated blower and valve assembly. Use of a longer lower air line valve spring 842 again allows for reduced lifting force by the lower air line valve servo 844, while still preserving a good air seal when the lower air line valve 840 is in the closed position.

FIG. 22B shows another possible position of the upper air line valve servo arm 834A of the upper air line valve servo 834 and of the lower air line valve servo arm 844A of the lower air line valve servo 844. As shown in FIG. 22B, the upper air line valve servo arm 834A or lower air line valve servo arm 844A is in an intermediate position, which may be at about 45 degrees, and which may be used to partially lift the upper air line valve plunger 830A and upper air line valve seal 830B or lower air line valve plunger 840A and lower air line valve seal 840B from the upper air line valve seal engaging lip 830C or lower air line valve seal engaging lip 840C, respectively. In this way, the upper air line valve 830 or lower air line valve 840 may be used to bleed air in a controlled fashion from the upper bladder 540 or lower bladder 510, respectively.

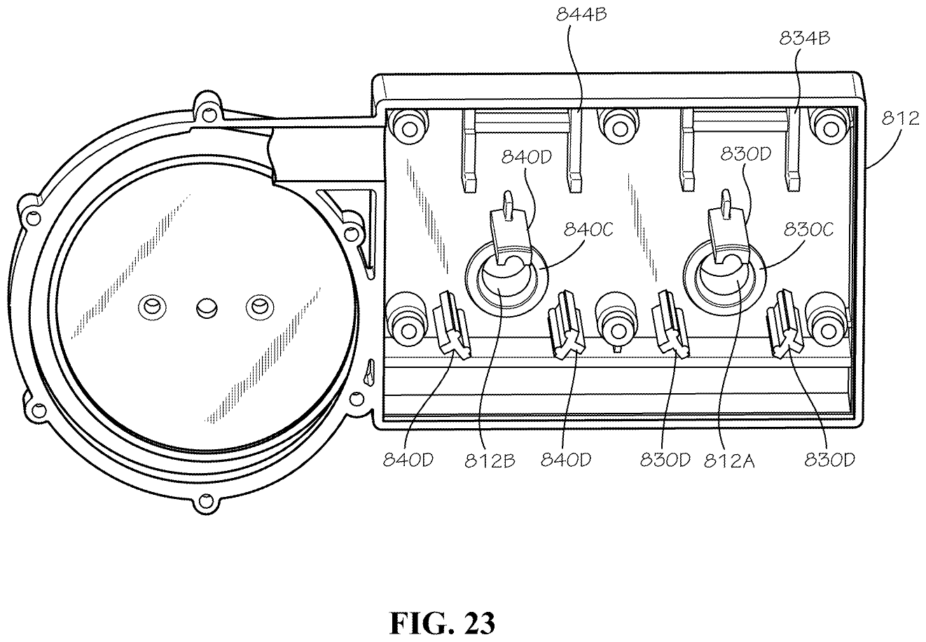

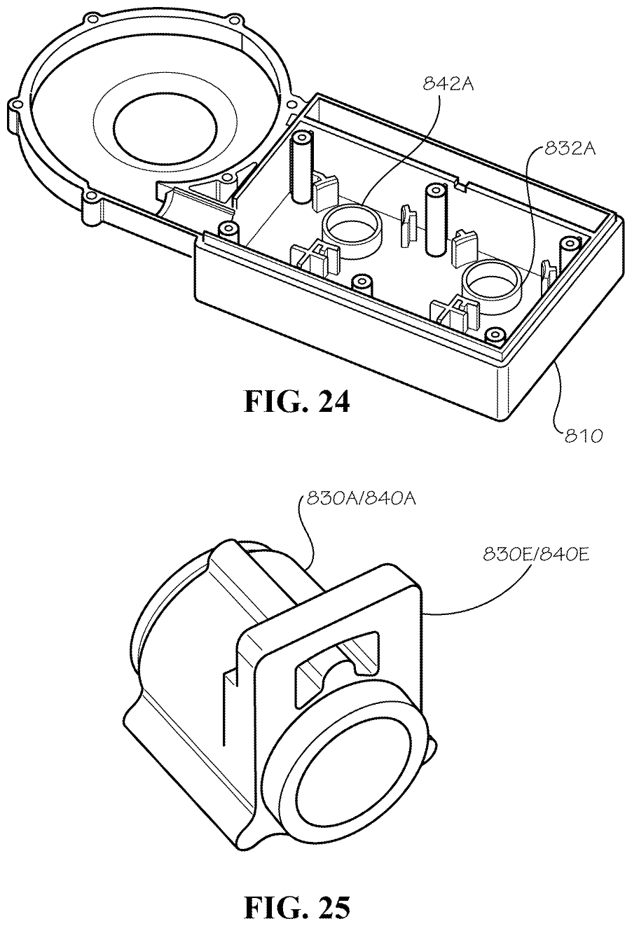

Further details of the upper housing 812, lower housing 810, and upper/lower air line valve plunger 830A/840A are shown in FIGS. 23, 24, and 25, respectively. The view of the upper housing 812 in FIG. 23 shows in greater detail the upper air line valve guides 830D that keep the upper air line valve plunger 830A (not shown) in alignment with the upper air line valve seal engaging lip 830C of the upper housing upper air line nipple 812A, as well as the lower air line valve guides 840D that keep the lower air line valve plunger 840A (not shown) in alignment with the lower air line valve seal engaging lip 840C of the upper housing lower air line nipple 812B. The view of the upper housing 812 in FIG. 23 also shows in greater detail the upper air line valve servo seat 834B and lower air line valve servo seat 844B in which the upper air line valve servo 834 and lower air line valve servo 844 (not shown) are to be placed, respectively. The view of the lower housing 810 in FIG. 24 shows in greater detail the upper air line valve spring seat 832A and lower air line valve spring seat 842A. The view of the upper/lower air line valve plunger 830A/840A in FIG. 25 shows in greater detail the upper/lower air line valve loop 830E/840E.

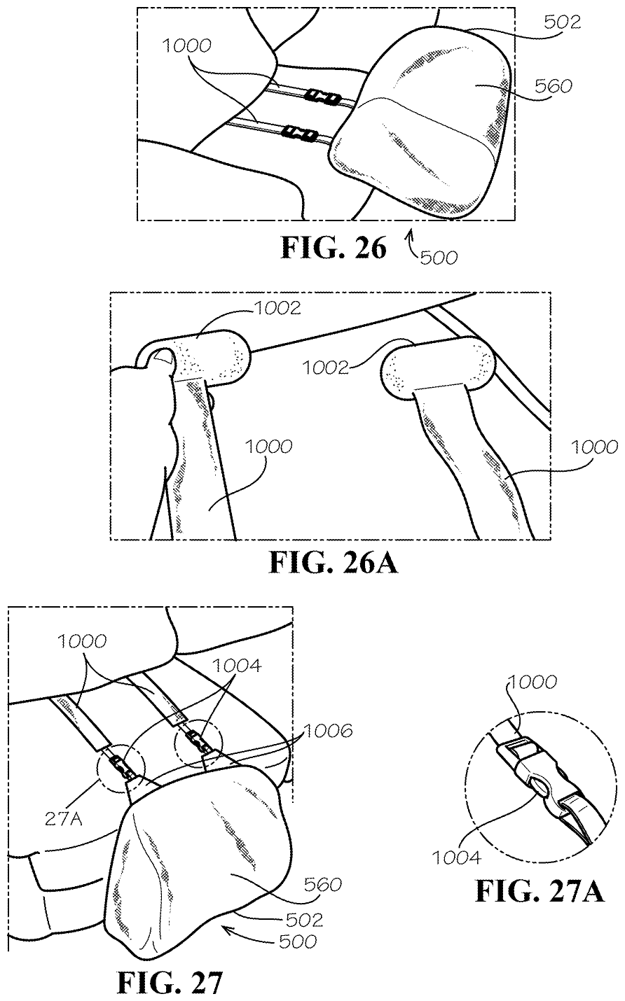

Turning now to FIG. 26, the inflatable pillow system 500 is shown inflated with the recliner in the reclined position. The inflatable pillow system 500 may be provided with seat straps 1000, which function to hold the pillow 502 in place and prevent it from moving away from the user. This may be particularly important when the user of the inflatable pillow system 500 experiences excessive leg movement, for non-limiting example having Restless Leg Syndrome (RLS). The seat straps 1000 may be provided with tuck pads or blocks 1002 which may be pushed into the crevice between the seat cushion and the back of the recliner, as shown in FIG. 26A. The tuck pads or blocks 1002, in conjunction with the weight of the user of the inflatable pillow system 500 sitting on the seat straps 1000, securely resist any tendency of the pillow 502 to move away from the user.

As shown in FIG. 27, the seat straps 1000 are connected to the outer case 560 of the pillow 502 of the inflatable pillow system 500 by way of ears 1006 sewn to the outer case 560. Additional ears 1006 may be located on the opposite side of the pillow 502 (not visible) so that the seat straps 1000 may be connected to either side of the pillow 502. In this way, if the user desires to relocate the blower and valve assembly 600 (not visible) to the other side of the leg rest of the recliner, it is a simple matter of disconnecting the seat straps 1000 from one side of the outer case 560 of the pillow 502, and reconnecting them to the other side of the outer case 560 of the pillow 502. To facilitate this, and to facilitate adjustment, the seat straps 1000 may be provided with adjustable snap connectors or side release buckles 1004. The ears 1006 on each side of the outer case 560 may each be provided with a mating portion of the adjustable snap connectors or side release buckles 1004 for this purpose. Additionally, the use of adjustable snap connectors or side release buckles 1004 allows the user to move the pillow 502 of the inflatable pillow system 500 to another support surface temporarily, while leaving the seat straps 1000 in place for later use, without requiring readjustment.

While the Inflatable Pillow System has been described with respect to at least one embodiment, the Inflatable Pillow System can be further modified within the spirit and scope of this disclosure, as demonstrated previously. With respect to the above description then, it is to be realized that the optimum dimensional relationships for the parts of the Inflatable Pillow System, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present Inflatable Pillow System. This application is therefore intended to cover any variations, modifications, uses, adaptations or equivalents of the Inflatable Pillow System using its general principles. Further, this application is intended to cover such departures from the present disclosure as come within known or customary practice in the art to which the disclosure pertains and which fall within the limits of the appended claims.

### REFERENCE NUMBER LISTING

| | | | |
|---|---|---|---|
| 10 | inflatable pillow system | 106 | upper bladder |
| 14 | recliner chair | 102 | upper chamber |
| 16 | seating section | 110 | upper bladder rectangular top panel |
| 18 | leg section | 112 | upper bladder rectangular bottom |
| | | | panel |
| | | 114 | upper bladder rectangular forward |
| | | | panel |
| 22 | pillow | 116 | upper bladder rectangular rearward |
| | | | panel |
| | | 118 | upper bladder trapezoidal side panels |
| 24 | lower bladder | | |
| 54 | lower chamber | 108 | lower bladder |
| 42 | lower bladder rectangular top panel | 170 | lower chamber |
| 44 | lower bladder rectangular bottom | 120 | lower bladder rectangular top panel |
| | panel | | |
| 46 | lower bladder rectangular forward | 122 | lower bladder rectangular bottom |
| | panel | | panel |
| 48 | lower bladder rectangular rearward | 124 | lower bladder rectangular forward |
| | panel | | panel |
| 52 | lower bladder trapezoidal side panels | 134 | lower bladder rectangular rearward |
| | | | panel |
| | | 138 | lower bladder trapezoidal side panels |
| 26 | upper bladder | | |
| 40 | upper chamber | 130 | releasable fasteners |
| 28 | upper bladder rectangular top panel | 132 | first strap |
| 30 | upper bladder rectangular bottom | 168 | second strap |
| | panel | | |
| 32 | upper bladder rectangular forward | 136 | positioning cords |
| | panel | | |
| 34 | upper bladder rectangular rearward | | |
| | panel | | |
| 38 | upper bladder trapezoidal side panels | 126 | stiffening plates |
| | | 128 | rectangular pockets |
| 58 | outer case | | |
| 62 | first straps | 140 | quick release valve |
| 64 | releasable fasteners | 142 | vertically disposed upper release line |
| 66 | second straps | 144 | axially aligned lower release line |
| 68 | releasable fasteners | 150 | horizontally disposed interior actuator |
| | | | line |
| | | 152 | axially aligned exhaust line |
| 72 | control assembly | | |
| 74 | air mover | 172 | primary piston |
| 76 | upper air line | 154 | cone shaped section |
| 78 | lower air line | 156 | cone shaped section |
| 90 | control box | 158 | cylindrical extensions |
| 80 | first up button (for upper bladder) | | |
| 82 | first down button (for upper bladder) | 174 | conical upper piston (upper release |
| | | | line) |
| 84 | second up button (for lower bladder) | 160 | conical upper stopper |
| 86 | second down button (for lower | 164A | upper 0-ring |
| | bladder) | | |
| | | 166A | upper coil spring |
| 100 | inflatable pillow system | | |
| 104 | outer case | | |
| 176 | conical lower piston (lower release | 510 | lower bladder |
| | line) | | |
| 162 | conical lower stopper | 512 | lower chamber |
| 164B | lower 0-ring | 514 | lower chamber baffles |
| 166B | lower coil spring | 516 | lower chamber baffle holes |
| | | 518 | lower bladder rectangular top panel |
| 148 | handler/single reciprocable | 520 | lower bladder rectangular bottom |
| | component | | panel |
| 146 | interior end | 522 | lower bladder forward panel |
| | | 524 | lower bladder rearward panel |
| 214 | reciprocable component | 526 | lower bladder rectangular side panels |
| 216 | reciprocable component | | |
| 252 | axially aligned line | 540 | upper bladder |
| 253 | axially aligned line | 542 | upper chamber |
| 204 | shaped component | 544 | upper chamber baffles |
| 206 | shaped component | 546 | upper chamber baffle holes |
| 218 | coil spring | 548 | upper bladder rectangular top panel |
| 220 | coil spring | 550 | upper bladder rectangular bottom |
| | | | panel |
| 208 | stopper | 552 | upper bladder forward panel |
| 210 | stopper | 554 | upper bladder rearward panel |
| 212A | 0-ring | 556 | upper bladder trapezoidal side panels |
| 212B | 0-ring | | |
| 200 | quick release valve | 560 | outer case |
| 248 | handler | 562 | valve & blower assembly |
| | | | recess/chamber |
| 242 | vertically disposed upper release line | | |
| 244 | axially aligned lower release line | 600 | blower and valve assembly |
| | | 602 | blower assembly |
| 300 | inflatable pillow system | 604 | valve assembly |
| 304 | upper bladder | 606 | blower assembly to valve assembly |
| | | | connector |
| 302 | rectangular side panels | | |
| 306 | lower bladder | 620 | blower lower housing |
| 312 | rectangular side panels | 622 | blower upper housing |
| 308 | topmost bladder | 624 | blower motor |
| 310 | pressure activated valve | 626 | blower motor adapter |
| | | 628 | blower motor housing |
| 400 | inflatable pillow system | 630 | impeller |
| 404 | top bladder | 632 | muffler/intake diffuser |
| 402 | triangular side panels | | |
| 406 | bottom bladder | 640 | valve assembly housing |
| 408 | triangular side panels | 642 | valve assembly lid |
| | | 644 | upper air line |
| 500 | inflatable pillow system | 646 | upper air line valve |
| 502 | pillow | 648 | lower air line |
| | | 650 | lower air line valve |
| 800 | integrated blower and valve | 840 | lower air line valve |
| | assembly | | |
| | | 840A | lower air line valve plunger |
| 810 | lower housing | 840B | lower air line valve seal |
| 812 | upper housing | 840C | lower air line valve seal engaging lip |
| 812A | upper housing upper air line nipple | 840D | lower air line valve guides |
| 812B | upper housing lower air line nipple | 840E | lower air line valve loop |
| 814 | blower motor | 842 | lower air line valve spring |
| 816 | blower motor housing | 842A | lower air line valve spring seat |
| 818 | impeller | 844 | lower air line valve servo |
| 820 | muffler/intake diffuser | 844A | lower air line valve servo arm |
| | | 844B | lower air line valve servo seat |
| 830 | upper air line valve | | |
| 830A | upper air line valve plunger | 900 | printed circuit board |
| 830B | upper air line valve seal | | |
| 830C | upper air line valve seal engaging lip | 1000 | Seat straps |
| 830D | upper air line valve guides | 1002 | Tuck pads or blocks |
| 830E | upper air line valve loop | 1004 | Adjustable snap connectors/side |
| | | | release buckles |
| 832 | upper air line valve spring | 1006 | Ears |
| 832A | upper air line valve spring seat | | |
| 834 | upper air line valve servo | | |
| 834A | upper air line valve servo arm | | |
| 834B | upper air line valve servo seat | | |

What is claimed is:

1. An inflatable pillow system, comprising:
a pillow formed of a lower bladder and an upper bladder, the upper bladder being coupled to the lower bladder to form an enlarged cross sectional configuration;
a controller for independently inflating and deflating the upper bladder and the lower bladder, wherein the controller comprises:
an air mover;
a valve assembly in fluid communication with the air mover, the valve assembly having:
an upper air line coupled to the upper bladder,
a lower air line coupled to the lower bladder,
an upper air line valve in fluid communication with the upper air line, the upper air line valve urged into a closed position by an upper air line valve spring and movable into an open position by an upper air line valve servo, and
a lower air line valve in fluid communication with the lower air line, the lower air line valve urged into a closed position by a lower air line valve spring and movable into an open position by a lower air line valve servo; and
a control box operatively coupled to the air mover and to the valve assembly, the control box having an input for inflating and raising the upper bladder, an input for deflating and lowering the upper bladder, an input for inflating and raising the lower bladder, and an input for deflating and lowering the lower bladder.

2. The inflatable pillow system of claim 1, wherein:
the upper air line valve further comprises a hollow upper air line valve plunger and an upper air line valve seal, the upper air line valve spring extending into the hollow upper air line valve plunger; and
the lower air line valve further comprises a hollow lower air line valve plunger and a lower air line valve seal, the lower air line valve spring extending into the hollow lower air line valve plunger.

3. The inflatable pillow system of claim 2, wherein:
the upper air line having an upper air line valve seal engaging lip, the hollow upper air line valve plunger being kept in alignment with the upper air line valve seal engaging lip by way of upper air line valve guides and an upper air line valve loop, the upper air line valve loop providing a lifting surface engaged by an upper air line valve servo arm connected to the upper air line valve servo; and
the lower air line having a lower air line valve seal engaging lip, the hollow lower air line valve plunger being kept in alignment with the lower air line valve seal engaging lip by way of lower air line valve guides and a lower air line valve loop, the lower air line valve loop providing a lifting surface engaged by a lower air line valve servo arm connected to the lower air line valve servo.

4. The inflatable pillow system of claim 1, wherein:
the controller being configured to selectively:
inflate the upper bladder by engaging the air mover and opening the upper air line valve;
deflate the upper bladder by disengaging the air mover and opening the upper air line valve;
retain air in the upper bladder by closing the upper air line valve;
inflate the lower bladder by engaging the air mover and opening the lower air line valve;
deflate the lower bladder by disengaging the air mover and opening the lower air line valve; and
retain air in the lower bladder by closing the lower air line valve.

5. The inflatable pillow system of claim 4, wherein:
the upper air line valve being further movable into an intermediate position by the upper air line valve servo, the controller being further configured to selectively bleed air from the upper bladder by disengaging the air mover and moving the upper air line valve into the intermediate position; and
the lower air line valve being further movable into an intermediate position by the lower air line valve servo, the controller being further configured to selectively bleed air from the lower bladder by disengaging the air mover and moving the lower air line valve into the intermediate position.

6. The inflatable pillow system of claim 1, wherein:
the lower bladder being shorter in length than the upper bladder, thereby providing a recess or chamber, the air mover and valve assembly being arranged within the recess or chamber.

7. The inflatable pillow system of claim 1, wherein:
the air mover and valve assembly being one of:
contained within separate housings connected by a connector, and
contained within a single integrated housing.

8. The inflatable pillow system of claim 1, further comprising:
a quick release valve for deflating the upper and lower bladders having:
an upper release line coupled to the upper bladder and a lower release line coupled to the lower bladder;
an interior actuator line and an exhaust line;
a reciprocable primary piston in at least one of the interior actuator line and the exhaust line, the primary piston being formed with two cone shaped sections with apexes coupled together axially inwardly and with cylindrical extensions axially outwardly;
an upper piston reciprocable in the upper release line with an upper stopper and an upper coil spring urging the upper stopper into sealing contact with the exhaust line;
a lower piston reciprocable in the lower release line with a lower stopper and a lower coil spring urging the lower stopper into sealing contact with the exhaust line; and
at least one handler having an interior end engaged with the primary piston, and an exterior end under control of the user for initiating activation of the quick release valve.

9. The inflatable pillow system of claim 1, further comprising at least one of:
pull cords having a forward end attached to an outer case enclosing the upper bladder and the lower bladder, the pull cords extending rearward for being held and manipulated by a user for concurrently repositioning the upper and lower bladders;
a plurality of stiffening plates, each stiffening plate including a rectangular pocket formed in the bottom of the lower bladder to add stability to the lower bladder and to the system during use;
a muffler/intake diffuser connected to an intake of the air mover; and
at least one seat strap having at least one tuck pad or block.

10. A controller of an inflatable pillow system having a pillow formed of a lower bladder and an upper bladder, the upper bladder being coupled to the lower bladder to form an enlarged cross sectional configuration, comprising:
an air mover;
a valve assembly in fluid communication with the air mover, the valve assembly having:
an upper air line coupled to the upper bladder,
a lower air line coupled to the lower bladder,
an upper air line valve in fluid communication with the upper air line, the upper air line valve urged into a closed position by an upper air line valve spring and movable into an open position by an upper air line valve servo, and
a lower air line valve in fluid communication with the lower air line, the lower air line valve urged into a closed position by a lower air line valve spring and movable into an open position by a lower air line valve servo; and
a control box operatively coupled to the air mover and to the valve assembly, the control box:
being configured for independently inflating and deflating the upper bladder and the lower bladder,
having an input for inflating and raising the upper bladder,
having an input for deflating and lowering the upper bladder,
having an input for inflating and raising the lower bladder, and
having an input for deflating and lowering the lower bladder.

11. The controller of claim 10, wherein:
the upper air line valve further comprises a hollow upper air line valve plunger and an upper air line valve seal, the upper air line valve spring extending into the hollow upper air line valve plunger; and
the lower air line valve further comprises a hollow lower air line valve plunger and a lower air line valve seal, the lower air line valve spring extending into the hollow lower air line valve plunger.

12. The controller of claim 11, wherein:
the upper air line having an upper air line valve seal engaging lip, the hollow upper air line valve plunger being kept in alignment with the upper air line valve seal engaging lip by way of upper air line valve guides and an upper air line valve loop, the upper air line valve loop providing a lifting surface engaged by an upper air line valve servo arm connected to the upper air line valve servo; and
the lower air line having a lower air line valve seal engaging lip, the hollow lower air line valve plunger being kept in alignment with the lower air line valve seal engaging lip by way of lower air line valve guides and a lower air line valve loop, the lower air line valve loop providing a lifting surface engaged by a lower air line valve servo arm connected to the lower air line valve servo.

13. The controller of claim 10, wherein:
the controller being configured to selectively:
inflate the upper bladder by engaging the air mover and opening the upper air line valve;
deflate the upper bladder by disengaging the air mover and opening the upper air line valve;
retain air in the upper bladder by closing the upper air line valve;
inflate the lower bladder by engaging the air mover and opening the lower air line valve;
deflate the lower bladder by disengaging the air mover and opening the lower air line valve; and
retain air in the lower bladder by closing the lower air line valve.

14. The controller of claim 13, wherein:
the upper air line valve being further movable into an intermediate position by the upper air line valve servo, the controller being further configured to selectively bleed air from the upper bladder by disengaging the air mover and moving the upper air line valve into the intermediate position; and
the lower air line valve being further movable into an intermediate position by the lower air line valve servo, the controller being further configured to selectively bleed air from the lower bladder by disengaging the air mover and moving the lower air line valve into the intermediate position.

15. The controller of claim 10, wherein:
the air mover and valve assembly being one of:
contained within separate housings connected by a connector, and
contained within a single integrated housing.

16. The controller of claim 10, further comprising:
a muffler/intake diffuser connected to an intake of the air mover.

17. A method for elevating at least one extremity of a patient, comprising the steps of:
forming a pillow out of a lower bladder and an upper bladder;
coupling the upper bladder to the lower bladder to form an enlarged cross sectional configuration;
providing a controller for independently inflating and deflating the upper bladder and the lower bladder, wherein the controller comprises:
an air mover;
a valve assembly in fluid communication with the air mover, the valve assembly having:
an upper air line coupled to the upper bladder,
a lower air line coupled to the lower bladder,
an upper air line valve in fluid communication with the upper air line, the upper air line valve urged into a closed position by an upper air line valve spring and movable into an open position by an upper air line valve servo, and
a lower air line valve in fluid communication with the lower air line, the lower air line valve urged into a closed position by a lower air line valve spring and movable into an open position by a lower air line valve servo; and
a control box operatively coupled to the air mover and to the valve assembly, the control box having an input for inflating and raising the upper bladder, an input for deflating and lowering the upper bladder, an input for inflating and raising the lower bladder, and an input for deflating and lowering the lower bladder.

18. The method of claim 17, wherein:
the upper air line valve further comprises a hollow upper air line valve plunger and an upper air line valve seal, the upper air line valve spring extending into the hollow upper air line valve plunger; and
the lower air line valve further comprises a hollow lower air line valve plunger and a lower air line valve seal, the lower air line valve spring extending into the hollow lower air line valve plunger.

19. The method of claim 17, wherein:
the upper air line having an upper air line valve seal engaging lip, the hollow upper air line valve plunger being kept in alignment with the upper air line valve seal engaging lip by way of upper air line valve guides and an upper air line valve loop, the upper air line valve loop providing a lifting surface engaged by an upper air line valve servo arm connected to the upper air line valve servo; and
the lower air line having a lower air line valve seal engaging lip, the hollow lower air line valve plunger being kept in alignment with the lower air line valve seal engaging lip by way of lower air line valve guides and a lower air line valve loop, the lower air line valve loop providing a lifting surface engaged by a lower air line valve servo arm connected to the lower air line valve servo.

20. The method of claim 17, further comprising the steps of:
configuring the controller to selectively:
inflate the upper bladder by engaging the air mover and opening the upper air line valve;
deflate the upper bladder by disengaging the air mover and opening the upper air line valve;
retain air in the upper bladder by closing the upper air line valve;
inflate the lower bladder by engaging the air mover and opening the lower air line valve;
deflate the lower bladder by disengaging the air mover and opening the lower air line valve; and
retain air in the lower bladder by closing the lower air line valve.

21. The method of claim 20, wherein:
the upper air line valve being further movable into an intermediate position by the upper air line valve servo, the controller being further configured to selectively bleed air from the upper bladder by disengaging the air mover and moving the upper air line valve into the intermediate position; and
the lower air line valve being further movable into an intermediate position by the lower air line valve servo, the controller being further configured to selectively bleed air from the lower bladder by disengaging the air mover and moving the lower air line valve into the intermediate position.

22. The method of claim 17, further comprising the steps of:
providing a quick release valve for deflating the upper and lower bladders having:
an upper release line coupled to the upper bladder and a lower release line coupled to the lower bladder;
an interior actuator line and an exhaust line;
a reciprocable primary piston in at least one of the interior actuator line and the exhaust line, the primary piston being formed with two cone shaped sections with apexes coupled together axially inwardly and with cylindrical extensions axially outwardly;
an upper piston reciprocable in the upper release line with an upper stopper and an upper coil spring urging the upper stopper into sealing contact with the exhaust line;
a lower piston reciprocable in the lower release line with a lower stopper and a lower coil spring urging the lower stopper into sealing contact with the exhaust line; and
at least one handler having an interior end engaged with the primary piston, and an exterior end under control of the user for initiating activation of the quick release valve.
